(19) United States
(12) Patent Application Publication
(10) Pub. No.: US 2024/0110705 A1
(43) Pub. Date: Apr. 4, 2024

(54) LATCH AND COOKING APPARATUS COMPRISING SAME

(71) Applicant: SAMSUNG ELECTRONICS CO., LTD., Suwon-si (KR)

(72) Inventors: Sooncheol KWEON, Suwon-si (KR); Joongkyung PARK, Suwon-si (KR); Junghoon PARK, Suwon-si (KR)

(73) Assignee: SAMSUNG ELECTRONICS CO., LTD., Suwon-si (KR)

(21) Appl. No.: 18/534,084

(22) Filed: Dec. 8, 2023

Related U.S. Application Data
(63) Continuation of application No. PCT/KR2022/009999, filed on Jul. 8, 2022.

(30) Foreign Application Priority Data
Jul. 26, 2021 (KR) 10-2021-0097891

(51) Int. Cl. F24C 15/02; E05C 3/14

(52) U.S. Cl. CPC F24C 15/022; E05C 3/14

(57) ABSTRACT

A cooking apparatus includes a housing, a door rotatably coupled to the housing, and including a key door protruding rearward, and a latch provided in the housing to lock the door, and configured to detect opening or closing of the door. The latch includes a latch housing coupled to the housing, a lever rotatably coupled to the latch housing, and rotatable about a rotation axis, and a block lever slidably coupled to the lever to prevent or allow a rotation of the lever. The block lever is pressed by the key door to slide to allow the rotation of the lever in response to the door being closed, and is configured to return to an original position by an elastic force of the lever in response to the door being opened.

### TECHNICAL FIELD

The disclosure relates to a latch and a cooking apparatus with the same, and more particularly, to a latch capable of being coupled to a housing and a cooking apparatus with the same.

### BACKGROUND ART

In general, cooking apparatuses are apparatuses for cooking an object to be cooked, such as food, by heating. For example, the cooking apparatuses may perform various functions related to cooking, such as heating, defrosting, drying, and sterilizing the object to be cooked. Such cooking apparatuses include, for example, ovens, such as gas ovens or electric ovens, microwave heating devices (hereinafter referred to as microwave ovens), gas ranges, electric ranges, gas grills, or electric grills.

Typically, an oven is an apparatus for cooking food by transferring heat directly to the food or by heating the interior of a cooking chamber by a heating source that generates heat, such as a heater, while a microwave oven is an apparatus for cooking food by the intermolecular frictional heat generated by disturbing a molecular arrangement of the food using high frequency as a heating source.

In the case of cooking apparatuses using magnetrons, it is important to control the high frequencies so that the high frequencies are not generated when a door is opened because the high frequencies generated by the cooking apparatuses are harmful to the human body.

The cooking apparatus may include a latch that detects the opening of a door. The latch uses a number of components to detect the opening of the door. As the number of components increases, the cost of manufacture increases and the possibility of failure increases, and it is therefore necessary to reduce the number of components.

### DISCLOSURE

### Technical Problem

The disclosure is directed to providing a latch including a block lever that functions as a single component that functions corresponding to several components used in the latch, and a cooking apparatus with the same.

### Technical Solution

According to an embodiment of the disclosure, a cooking apparatus includes a housing, a door rotatably coupled to the housing and including a key door protruding rearward, and a latch provided in the housing to lock the door and configured to detect opening and closing of the door, wherein the latch includes a latch housing coupled to the housing, a lever rotatably coupled to the latch housing about a rotation axis, and a block lever slidably coupled to the lever to prevent or allow a rotation of the lever, wherein the block lever is pressed by the key door to slide to allow the rotation of the lever in response to the door being closed, and is configured to return to its original position by an elastic force of the lever itself in response to the door being opened.

The block lever may include a first lever body extending in a first direction, a second lever body extending in a second direction forming a predetermined angle with the first direction and having one end in contact with the inside of the lever, and a third lever body having one end coupled to the other end of the first lever body and the other end coupled to the other end of the second lever body, when the door is closed, the first lever body is pressed by the key door to be brought closer to the second lever body, so that an elastic force is accumulated in the block lever.

The lever may include a lever opening provided at a position at which the key door is to be entered when the door is closed, and the first lever body may include a block lever pusher received in the lever opening side and in contact with the key door, and a block lever guide extending from the block lever pusher in the first direction and configured to guide a movement of the block lever.

The latch housing may include a key door opening provided at a position at which the key door is to be entered when the door is closed, the lever may further include a lever hook extending from the rotation axis in a direction toward the key door opening, the key door may include a key door hole to receive the lever hook, and when the key door enters the inside of the lever, the lever hook may be received in the key door hole to allow the lever to rotate.

The lever hook and the block lever pusher may be received in the key door opening, and a width of the block lever pusher may be narrower than that of the lever hook.

The block lever pusher may become narrower in width towards the key door opening.

The block lever pusher may include a pusher guide surface that limits a movement of the block lever pusher on a surface facing in a direction opposite to the direction toward the key door opening, and the latch housing may further include an anti-rotation portion located adjacent to the key door opening, protruding in the direction opposite to the direction toward the key door opening, and including an anti-rotation guide surface provided by a predetermined distance so as to prevent the lever from rotating while the block lever moves a predetermined distance.

The block lever guide may include a guide recess formed concave in a direction opposite to a direction toward the rotation axis and extending in the first direction by a distance that the block lever is movable, and the lever may include a lever guide seated in the guide recess to guide the distance that the block lever is movable, and protruding in a direction of the guide recess.

The block lever may further include a block lever stopper protruding in a direction away from the rotation axis, and the lever may further include a lever stopper configured to stop a movement of the block lever by contacting the block lever stopper after the block lever is moved a predetermined distance.

The lever may include an inner guide disposed at a position surrounded by the first lever body, the second lever body, and the third lever body, and the inner guide may guide a movement of the block lever by moving in contact with one surface of the inner guide when the block lever moves.

The lever may include a guide inclined surface in contact with an end of the third lever body and configured to guide the third lever body to approach the first lever body when the key door enters the inside of the latch, the guide inclined surface being formed on the inside of the lever.

The third lever body may further include an inclined surface protrusion bent and extended at the end thereof in a direction opposite to the direction toward the rotation axis, and moving in contact with the guide inclined surface.

The lever may include a lever hook extending from one side of the lever and having an end contacting the key door when the key door enters, the block lever may be located on the inside of the lever, a width of the block lever being narrower than that of the lever hook, and the latch may further include an elastic member connecting the block lever and the lever to elastically bias the block lever in a direction toward the key door.

The block lever may include a first lever body extending in a first direction and a second lever body coupled to a side portion of the first lever body and extending in a second direction, the second lever body may include an inclined surface protrusion bent in a direction toward the latch housing at an end thereof, the inclined surface protrusion may contact the inside of the lever, the lever may include a guide inclined surface moving in contact with the bent end of the second lever body and may further include a lever guide having the shape of a groove in which the second lever body is accommodated and guided, and when the door is closed, the first lever body may be pressed by the key door to be brought closer to the second lever body in a direction of the rotation axis, so that an elastic force is accumulated in the block lever.

The second lever body may include a block lever protrusion protruding in a direction toward the latch housing and including an inclined surface, and the latch housing may further include an anti-rotation guide surface having the shape of groove to receive the block lever protrusion and provided by a predetermined distance so as to prevent the lever from rotating while the block lever moves a predetermined distance, and when the door is closed, the first lever body may be pressed by the key door to be brought closer to the second lever body, so that an elastic force is accumulated in the block lever.

According to another embodiment of the disclosure, a latch includes a latch housing, a lever rotatably coupled to the latch housing about a rotational axis, and a block lever slidably coupled to the lever to prevent or allow a rotation of the lever, wherein the block lever is pressed by an object to be detected to slide to allow the rotation of the lever in response to the object to be detected attempting to enter the inside of the latch, and is configured to return to its original position by an elastic force of the block lever itself in response to the object to be detected exiting the inside of the latch.

The block lever may include a first lever body extending in a first direction, a second lever body extending in a second direction forming a predetermined angle with the first direction and having one end in contact with the inside of the lever, and a third lever body having one end coupled to the other end of the first lever body and the other end coupled to the other end of the second lever body, when the object to be detected attempts to enter the inside of the latch, the first lever body may be brought closer to the second lever body, so that an elastic force may be accumulated in the block lever.

The lever may include a lever opening provided in a position at which the key door is to be entered in response to the door being closed, and the first lever body may include a block lever pusher received in the lever opening side and in contact with the key door, and a block lever guide extending from the block lever pusher in the first direction and configured to guide a movement of the lever. The latch housing may include a key door opening provided in a position at which the key door is to be entered in response to the door being closed, the lever may further include a lever hook extending from the rotation axis in a direction toward the key door opening, the key door may include a key door hole to receive the lever hook, and when the key door enters the inside of the lever, the lever hook may be received in the key door hole to allow the lever to rotate. The lever hook and the block lever pusher may be received in the key door opening, and a width of the block lever pusher may be narrower than that of the lever hook.

According to still another embodiment of the disclosure, a cooking apparatus includes a housing, a door rotatably coupled to the housing and including a key door protruding rearward, and a latch provided in the housing to lock the door and configured to detect opening and closing of the door, wherein the latch includes a latch housing coupled to the housing, a lever rotatably coupled to the latch housing about a rotation axis, and a block lever slidably coupled to the lever to prevent or allow a rotation of the lever, wherein the block lever is pressed by the key door to slide to allow the rotation of the lever in response to the door being closed, and is configured to return to its original position by an elastic force of the lever itself in response to the door being opened, wherein the block lever includes a first lever body extending in a first direction, a second lever body extending in a second direction forming a predetermined angle with the first direction and having one end in contact with the inside of the lever, when the door is closed, the first lever body is pressed by the key door to be brought closer to the second lever body, so that an elastic force is accumulated in the block lever, and a third lever body having one end coupled to the other end of the first lever body and the other end coupled to the other end of the second lever body, wherein the second lever body includes a block lever protrusion protruding in a direction toward the latch housing and including an inclined surface, and the latch housing further includes an anti-rotation portion including an anti-rotation guide surface having the shape of groove to receive the block lever protrusion and provided by a predetermined distance so as to prevent the lever from rotating while the block lever moves a predetermined distance, when the key door enters the inside of the latch, the first lever body may be brought closer to the second lever body.

The latch housing may include a key door opening provided in a position at which the key door is to be entered when the door is closed, and the lever may include a lever opening provided in a position at which the key door is to be entered when the door is closed, wherein the first lever body may include a block lever pusher received in the lever opening side and in contact with the key door and a block lever guide extending from the block lever pusher in the first direction and configured to guide a movement of the lever, and the block lever pusher may include a pusher guide surface that limits a movement of the block lever pusher on a surface facing in a direction opposite to the direction toward the key door opening, and the latch housing may further include an anti-rotation portion located adjacent to the key door opening, protruding in the direction opposite to the direction toward the key door opening, and including an anti-rotation guide surface provided by a predetermined distance so as to prevent the lever from rotating while the block lever moves a predetermined distance.

### Advantageous Effects

According to various embodiments of the present disclosure, the cooking apparatus may perform the functions of several components in the block lever component, thereby reducing manufacturing cost and the possibility of failure.

### DESCRIPTION OF DRAWINGS

FIG. 1 is a perspective view illustrating an exterior of a cooking apparatus according to a first embodiment of the present disclosure.

FIG. 2 is a perspective view of a partial configuration of the inside of the cooking apparatus shown in FIG. 1.

FIG. 3 is a cross-sectional view of FIG. 1, cut from the inside of a door along a plane parallel to a front plate.

FIG. 4 is an exploded perspective view of the cooking apparatus shown in FIG. 1, disassembled.

FIG. 5 is a rear perspective view of the cooking apparatus of FIG. 1 from a rear with an outer housing removed.

FIG. 6 is a rear perspective view of a latch of the cooking apparatus of FIG. 1 from the rear.

FIG. 7 is a side view of the latch of FIG. 6 from a side.

FIG. 8 is an exploded perspective view of the latch of FIG. 6, disassembled.

FIG. 9 is an exploded perspective view of the latch of FIG. 8 from another side.

FIG. 10 is a perspective view illustrating a block lever of the latch of FIG. 8.

FIG. 11 is a front view illustrating a lever and the block lever of the latch of FIG. 8.

FIG. 12 is an enlarged perspective view illustrating the latch when the door of the cooking apparatus of FIG. 5 is open.

FIG. 13 is an enlarged perspective view illustrating the latch when the door of the cooking apparatus of FIG. 12 is closed.

FIG. 14 is a side view illustrating the latch and a key door of the cooking apparatus of FIG. 5 just before the door is closed.

FIG. 15 is a side view illustrating a state in which the key door enters the latch of FIG. 14 and a block lever pusher is released from an anti-rotation portion.

FIG. 16 is a side view illustrating a state in which the key door further enters the latch of FIG. 15 and the block lever does not move further with respect to the lever.

FIG. 17 is a side view illustrating a timing at which the key door further enters the latch of FIG. 16, wherein a direction of a force exerted by an elastic member on the lever is changed.

FIG. 18 is a side view illustrating the key door further enters the latch of FIG. 17 to allow a second sensor to be detected.

FIG. 19 is a side view illustrating the lever, the block lever, and the anti-rotation portion.

FIG. 20 is a side view illustrating the latch according to a second embodiment of the present disclosure.

FIG. 21 is a side view illustrating a latch according to a third embodiment of the present disclosure.

FIG. 22 is an exploded perspective view of the latch of FIG. 21, disassembled.

FIG. 23 is a perspective view of the block lever of the latch of FIG. 21.

FIG. 24 is a side view illustrating a latch according to the fourth embodiment.

FIG. 25 is an exploded perspective view of the latch of FIG. 24, disassembled.

FIG. 26 is a perspective view illustrating the lever of the latch of FIG. 25 from the rear.

FIG. 27 is a perspective view of the block lever of FIG. 24.

### MODES OF THE INVENTION

Embodiments described in the disclosure and configurations shown in the drawings are merely examples of the embodiments of the disclosure and may be modified in various different ways at the time of filing of the present application to replace the embodiments and drawings of the disclosure.

In addition, the same reference numerals or signs shown in the drawings of the disclosure indicate elements or components performing substantially the same function.

Also, the terms used herein are used to describe the embodiments and are not intended to limit and/or restrict the disclosure. The singular forms “a,” “an” and “the” are intended to include the plural forms as well, unless the context clearly indicates otherwise. In this disclosure, the terms “including”, “having”, and the like are used to specify features, figures, steps, operations, elements, components, or combinations thereof, but do not preclude the presence or addition of one or more of the features, figures, steps, operations, elements, components, or combinations thereof.

It will be understood that, although the terms first, second, primary, secondary, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

The terms “front”, “rear”, “upper”, “lower”, “top”, and “bottom” as herein used are defined with respect to the drawings, but the terms may not restrict the shape and position of the respective components.

Hereinafter, an embodiment according to the disclosure will be described in detail with reference to the accompanying drawings.

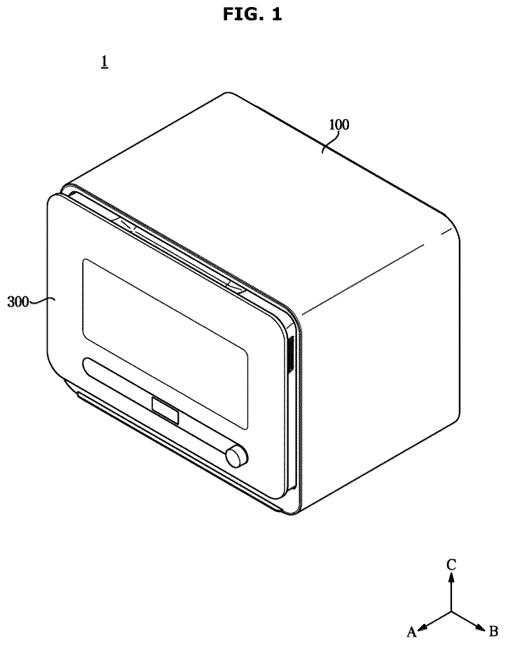

FIG. 1 is a perspective view illustrating an exterior of a cooking apparatus 1 according to a first embodiment of the present disclosure.

As shown in FIG. 1, the cooking apparatus 1 may include an outer housing 100 that forms the exterior of the cooking apparatus 1, and a door 300 that may open and close a front side of the outer housing 100.

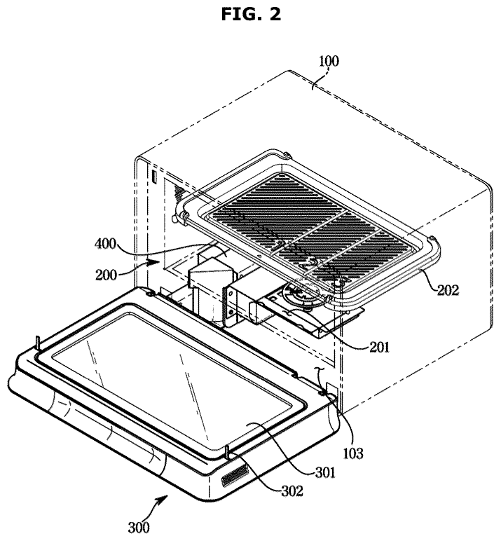

FIG. 2 is a perspective view illustrating a number of configurations of an interior of the cooking apparatus 1 shown in FIG. 1.

As shown in FIG. 2, the cooking apparatus 1 may include an inner housing 200 disposed within the outer housing 100 and forming a cooking chamber 201.

The outer housing 100 and the inner housing 200 may be provided to be open towards the front side of the cooking apparatus 1.

Users may place food into the cooking chamber 201 or out of the cooking chamber 201 through an opening of the inner housing 200.

The cooking chamber 201 may have a substantially rectangular parallelepiped shape.

The cooking apparatus 1 may include a machine chamber 103 formed within the outer housing 100 and disposed below the cooking chamber 201. Various electrical components (not shown) that drive the cooking apparatus 1 may be placed therein.

The cooking apparatus 1 may include a door 300 provided to open and close the openings of the outer housing 100 and the inner housing 200.

The door 300 may include a key door 302 protruding from a rear surface of the door 300. The key door 302 may interact with a latch 500, which will be described below, and allow the latch 500 to lock the door and detect the opening and closing of the door 300.

An inputter (not shown) or a manipulator (not shown) that inputs a signal to allow the user to control the cooking apparatus 1 may be provided on a front surface of the door 300. The inputter (not shown) or the manipulator (not shown) may include a display (not shown) for displaying an image or a touch device (not shown) provided to input a signal by touching the image.

The door 300 may include a viewing window that allows the user to observe the interior of the cooking chamber 201 when the door 300 is closed.

The cooking apparatus 1 may include a tray 202 which is held in the cooking chamber 201 and on which the user may place food. The tray 202 may be provided to be detachably held in the cooking chamber 201.

The cooking apparatus 1 may include a heating source 400 for heating to the inside of the cooking chamber 201 to allow the food to be cooked by heat.

The heating source 400 may provide heat to the food placed on the tray 202 so that the food may be cooked. Additionally, food may be located on a lower surface of the cooking chamber 201 without the tray 202. At this time, the heating source 400 may provide heat to the food located on the lower surface thereof.

The heating source 400 may include a magnetron 400 for generating high frequencies. The high frequency generated by the magnetron 400 may be directed into the inside of an object to be cooked (e.g., food) to cook the inside of the food by frictional heat between the molecules generated by repeatedly converting the molecular arrangement of the water contained in the food.

The magnetron 400 may be placed in the machine chamber 103. The magnetron 400 may oscillate high frequencies from the machine chamber 103 towards the lower surface of the cooking chamber 201, and the high frequencies may pass through the lower surface thereof and then be irradiated to the tray 202.

The heating source 400 may include a heater (not shown). The heater (not shown) may transfer heat directly to the food by radiating heat generated from itself.

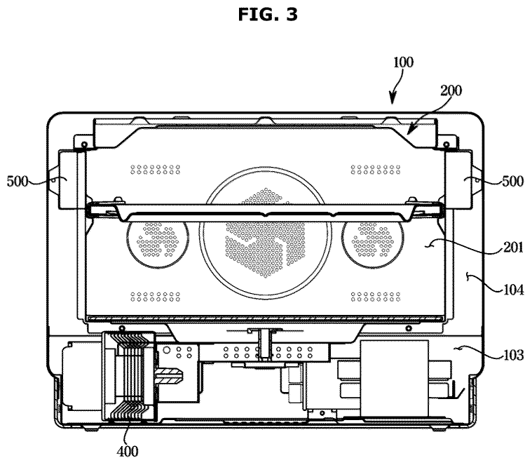

FIG. 3 is a cross-sectional view of FIG. 1 cut along a plane parallel to a front plate 120 from the inside of the door 300.

As shown in FIG. 3, the cooking apparatus 1 may include a certain space 104 between the inner housing 200 and the outer housing 100.

The space 104 may be provided with the latch 500. A location of the latch 500 is not limited to any location. However, in the present specification, for the sake of illustration, the latch 500 is shown and described herein as being located on a front upper side of the space 104.

The latch 500 provided to detect the opening and closing of the door 300 may be one in the cooking apparatus 1. However, if there is only one latch 500, the opening of the door 300 may not be detected by the latch 500 when the door 300 is twisted. This is because the door 300 may be closed only in a portion corresponding to the latch 500, and the door 300 may be twisted open in the remaining portion. Such a state may cause high frequencies to be emitted to the outside of the cooking apparatus 1, so that it is desirable to have two or more latches 500.

In the present specification, for ease of description, two latches 500 are illustrated herein. The latches 500 may be arranged on the left and right sides of the cooking apparatus 1, up and down, side by side, or symmetrically. The arrangement of the latches 500 may be not restricted by the form of the arrangement. However, for ease of description, the present disclosure will be based on the latches 500 being arranged on the left and right sides and on the front upper side of the space 104.

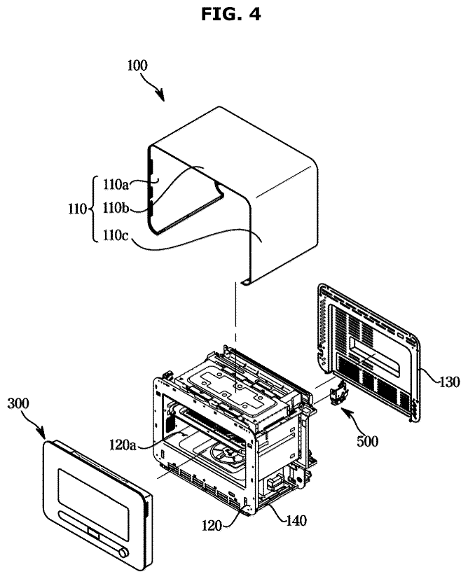

FIG. 4 is an exploded perspective view of the cooking apparatus 1 shown in FIG. 1, disassembled.

As shown in FIG. 4, the cooking apparatus 1 may include the door 300, the outer housing 100, the inner housing 200, and the latch 500.

The outer housing 100 of the cooking apparatus 1 may include a top plate 110b, two side plates 110a and 110c, the front plate 120, a rear plate 130, and a bottom plate 140. The top plate 110b and the two side plates 110a and 110c may be formed as one piece, which may be referred to as the housing cover 110.

The front plate 120 may be coupled to a front side of the inner housing 200. The front plate 120 may serve to cover a front side of the machine chamber 103, to prevent electrical components (not shown) from being exposed to the outside, and to protect the inner housing 200. At this time, an opening for the cooking chamber 201 may be formed in the front plate 120, and the object to be cooked (e.g., food) may be put into the cooking chamber 201 through the opening in the cooking chamber 201.

As described above, the housing cover 110 may be formed as one body including the top plate 110b and the two side plates 110a and 110c. The housing cover 110 may function to protect the cooking apparatus 1 from the outside.

The rear plate 130 may be coupled to a rear face of the inner housing 200 and may serve to protect electrical components (not shown) by preventing the electrical components from being exposed to the outside. In particular, some electrical components (not shown) that are vulnerable to shock, such as a printed circuit board (PCB), may be present on the rear face of the inner housing 200, and thus the rear plate 130 may serve to protect them.

The latches 500 may be coupled to the front plate 120. The positioning of the latches 500 will be described in more detail below.

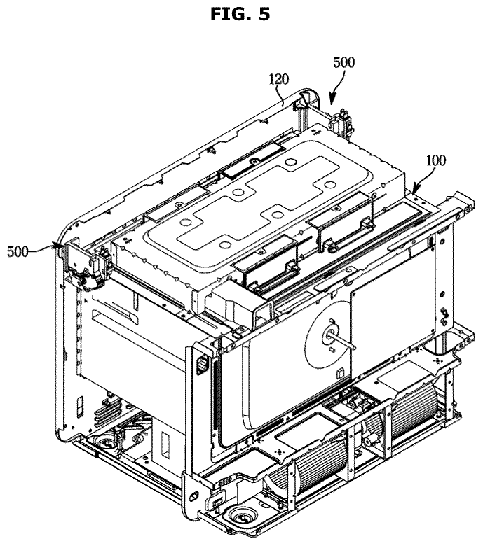

FIG. 5 is a rear perspective view of the cooking apparatus 1 of FIG. 1 from a rear in a state in which the outer housing 100 is removed.

As shown in FIG. 5, the latch 500 may each be coupled to the front plate 120. In particular, the respective latch 500 may be coupled to the rear face of the front plate 120. More particularly, the respective latch 500 may be coupled to an upper sidewall of the rear face of the front plate 120.

This is only a specific location for ease of description and is not limited thereto. For example, the latch 500 may each be coupled to a side face of the inner housing 200. However, in the case of the latch 500 being coupled to the front plate 120, tolerances due to assembly of the inner housing 200 may be avoided and the latch 500 may interact with the key door 302 of the door 300 at a more accurate position, thereby stably detecting the opening and closing of the door 300.

If the latch 500 is coupled to the side face of the inner housing 200, after the latch 500 is coupled, a process for adjusting the position of the latch 500 is required in order to enable the latch 500 to detect the opening and closing of the door 300 at an accurate position. This may increase manufacturing time due to additional processes and manufacturing costs.

Accordingly, as a kind of preferred embodiment, the door 300 will be described with the assumption that the door is coupled to the rear face of the front plate 120.

For ease of description, the following description is made based on a position of the key door 302, which is not inserted into the latch 500.

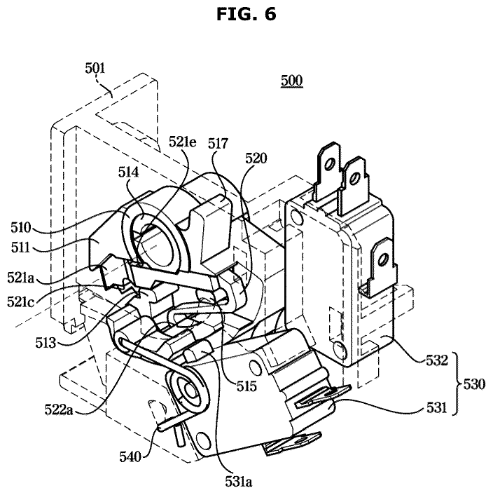

FIG. 6 is a rear perspective view illustrating the latch 500 of the cooking apparatus 1 of FIG. 1 from the rear.

The latch 500 may include a latch housing 501 provided to form an external appearance. The latch housing 500 may accommodate other components included in the latch 500 or provide a space to which other components may be coupled. The latch housing 501 may serve to protect other components accommodated or coupled to the housing from external impact.

The latch 500 may include a lever 510 rotatably coupled to the inside of the latch housing 501 about a rotation axis. The lever 510 may convert a movement of the lever 510 into a rotational movement of the lever 510 when the key door 302 is inserted into the latch 500 to serve to operate a sensor 530, which will be described later.

An accommodating space may be provided within the latch 500, and a block lever 520 may be movably positioned within the accommodating space. When the key door 302 is inserted into the latch 500, the shape of the block lever 520 may elastically change, causing the lever 510 to rotate in a direction opposite to a direction in which the lever 510 rotates.

The block lever 520 may be positioned between the lever 510 and the latch housing 501, which may prevent the block lever 520 from being released from the inside of the lever 510.

The sensor 530 may be coupled to the latch housing 501. The sensor 530 may be fixed by fitting between protrusions formed on the latch housing 501.

The sensor 530 may detect the opening and closing of the door 300. More specifically, when the door 300 is closed, the key door 302 may be inserted into the latch 500, the lever 510 may be rotated by the inserted key door 302, and the rotation of the lever 510 may cause the sensor 530 to be actuated.

Although one sensor 530 may be provided, it is preferable that a plurality of sensors 530 are provided. If there is only one sensor 530, the sensor 530 may not be activated by the closing of the door 300, but by any manipulation by the user. This means that when the door 300 is open, high frequencies may escape and it is therefore necessary to prevent such escape. In view of the above, international treaties for devices using microwaves stipulates that three or more sensors 530 are required to be installed. Accordingly, it is desirable to have the plurality of sensors 530.

As discussed above, the description continues on the assumption that the cooking apparatus 1 may include the two latches 500. Accordingly, according to a preferred embodiment, the description herein assumes that the respective latch 500 may include the two sensors 530. At this time, the sensor 530 that first detects the rotation of the lever 510 may be referred to as a first sensor 531, and the sensor 530 that second detects the rotation of the lever 510 may be referred to as a second sensor 532.

The first sensor 531 and the second sensor 532 may be on different sides of the latch housing 501. If the two sensors are on the same side of the latch housing 501, the latch housing 501 needs to be correspondingly sized, as the sensors 530 need a space to operate in consideration of the volume occupied by the sensor 530. However, if the sensors 530 are on different sides of the latch housing 501, a first side of the latch housing 501 only needs to provide a space for one sensor 530, so the volume of the latch housing 501 may be smaller than if the sensors 530 are on the same side. The smaller the volume of the latch housing 501 becomes, the lower the production cost and the faster the production time may be. Furthermore, the reduced volume of the latch housing 501 may provide more options for where the sensor may be positioned within the cooking apparatus 1, allowing for design freedom.

The latch 500 may include an elastic member 540 that connects the lever 510 and the housing. The elastic member 540 may be a torsion spring. When the key door 302 enters the inside of the latch 500, the elastic member 540 may exert a force on the lever 510 to prevent the lever from rotating in response to the lever 510 not rotating beyond a predetermined angle, and may exert a force on the lever 510 to rotate in a direction in which the lever 510 is to rotate in response to the lever rotating more than the predetermined angle. Accordingly, if the user unintentionally attempts to activate the sensor 530, the rotation of the lever may be prevented, thereby inhibiting detection by the sensor, and if any movement is made to activate the sensor 530, the rotation of the lever 510 may be facilitate, thereby triggering detection by the sensor.

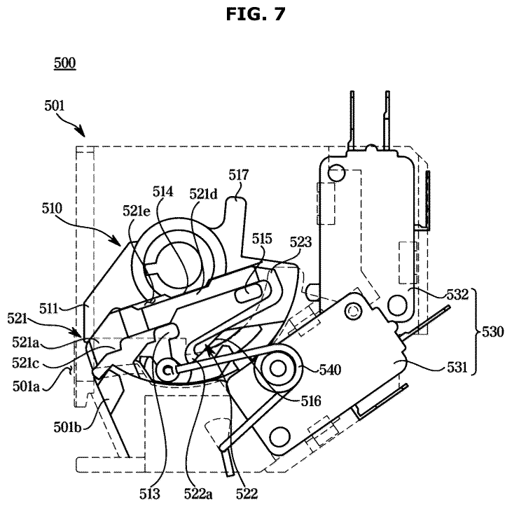

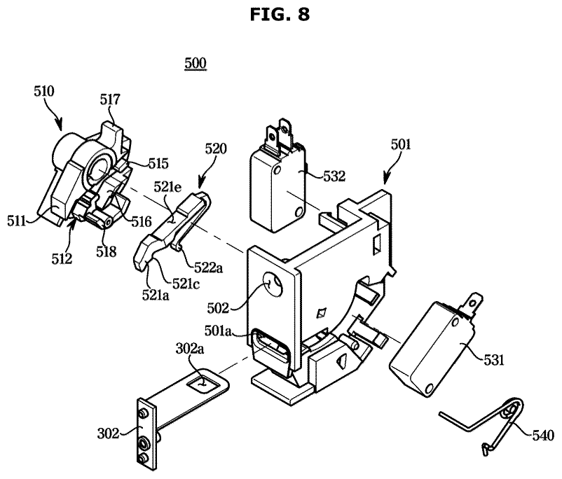

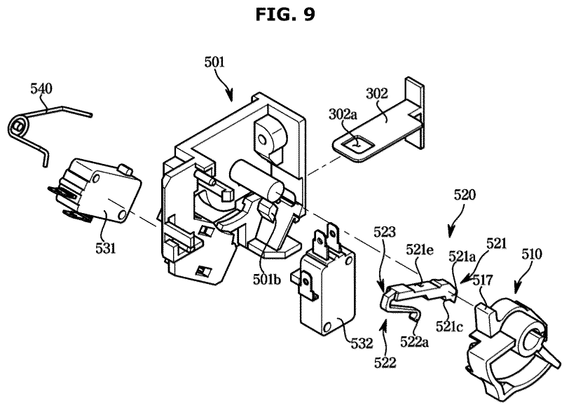

FIG. 7 is a side view illustrating the latch 500 of FIG. 6 from a side. FIG. 8 is an exploded perspective view of the latch 500 of FIG. 6 disassembled. FIG. 9 is an exploded perspective view of the latch 500 of FIG. 8 from another side.

Referring to FIGS. 7 to 9, as disrobed above, the latch 500 may include the latch housing 501, the lever 510, the block lever 520, the sensor 530, and the elastic member 540.

The block lever 520 may include a first lever body 521 extending in a first direction and having one end received towards a lever opening 512, which will be described later, a second lever body 522 extending in a second direction forming a predetermined angle with the first direction and having one end in contact with the inside of the lever 510, and a third lever body 523 having a first end coupled to the other end of the first lever body 521 and a second end coupled to the other end of the second lever body 522. When the key door 302 is inserted into the latch 500, the first lever body 521 may approach the second lever body 522, and elastically bias the block lever 520 to return to its original position.

The first lever body 521 may be a portion that is pressed against the key door 302.

The second lever body 522 may be elastically deformed to become closer to or farther away from the first lever body 521. When an elastic object is deformed, the elastic object may attempt to return to its original state. For an object having in the form of a hairpin, if a force is applied to portions corresponding to opposite ends of the hairpin so as to narrow a space therebetween, the hairpin may attempt to return to its original stretched form. Such a process may create a force that attempts to return the hairpin to its original extended form. When the second lever body 522 is also brought closer to the first lever body 521 according to the same principle, the entire block lever 520 may exert a force in a direction opposite to the deformation.

The third lever body 523 may be a portion that connects the first lever body 521 and the second lever body 522. Because the third lever body 523 serves as a connection, the third lever body 523 may not come into contact with the lever 510.

The latch housing 501 may include a key door opening 501a formed on a front surface thereof. The key door 302 may be inserted into the latch 500 through the key door opening 501a. Accordingly, the key door opening 501a may be formed at a position where the key door 302 may be inserted into the latch 500 when the door 300 is closed.

The block lever 520 may be located on the key door opening 501a side, and may include a block lever pusher 521a included in the first lever body 521. When the key door 302 is inserted into the latch 500 through the key door opening 501a, the key door 302 may come into contact with the block lever pusher 521a to apply force to the block lever 520.

The latch housing 501 may include an anti-rotation portion 501b having a shape that protrudes from the latch housing 501 in a direction toward the lever 510, adjacent to an end portion located in a direction toward the key door opening 501a of the block lever 520.

The anti-rotation portion 501b may be positioned in a direction in which an object is being inserted when the object is inserted into the latch 500. Accordingly, when the block lever 520 moves a certain distance, the block lever 520 may hit the anti-rotation portion 501b. When an object, such as the key door 302, is inserted into the latch 500 in a forward direction, the block lever 520 may move further beyond the anti-rotation portion 501b. However, when the object is inserted into the latch 500 in a direction different from the forward direction, the block lever 520 may not move further beyond a point where the block lever hits the anti-rotation portion 501b. As a result, the rotation of the lever 510 may be prevented.

Such anti-rotation portion 501b may include an anti-rotation guide surface 501c, which is a surface facing the block lever 520.

The first lever body 521 of the block lever 520 may include a pusher guide surface 521b interacting with the anti-rotation guide surface 501c and facing the anti-rotation guide surface 501c.

The latch housing 501 may include a coupling opening 502 provided for coupling to the front plate 120 (see FIG. 4) of the outer housing 100 (see FIG. 4).

The lever 510 may include a lever hook 511 extending from the rotation axis in the direction toward the key door opening 501a. When the key door 302 is not inserted into the latch 500, the lever hook 511 may be located on the key door opening 501a. When the key door 302 is inserted into the latch 500 while pushing only the lever hook 511, the pusher guide surface 521b included in the first lever body 521 of the block lever 520 may come into contact with the anti-rotation guide surface 501c of the anti-rotation portion 501b. In other words, when the key door 302 presses only the lever hook 511, the rotation of the lever 510 may not occur.

When the key door 302 presses the block lever pusher 521a of the block lever 520, the lever 510 may rotate to some extent. At this time, in the case of rotation caused by another object other than the key door 302, the lever hook 511 may press another object thereon, so that the lever 510 may no longer rotate. In other words, the lever hook 511 may serve to prevent the latch 500 from operating when an object other than the key door 302 is inserted into the latch 500.

However, the key door 302 may have a key door hole 302a, and as the lever 510 rotates, the lever hook 511 may be received in the key door hole 302a, so that the lever 510 may keep rotating without stopping.

In other words, if an object attempting to enter the inside of the latch 500 does not have the key door hole 302a, the object may not enter the latch 500 by a certain distance or more. When the lever 510 rotates to some extent, the lever hook 511 may move in a direction in contact with the object attempting to enter the inside of the latch 500. In order for the lever 510 to continue to rotate, the lever hook 511 may also continue to move, so the key door hole 302a is required to provide a space for the lever hook 511 to move.

The lever 510 may include the lever opening 512 provided in the direction toward the key door opening 501a. The block lever 520 located inside the lever 510 may have its end located in the lever opening 512. More precisely, the block lever pusher 521a may be located in the lever opening 512. Because the block lever pusher 521a may be located on the key door opening 501a side, the lever opening 512 may also be located toward the key door opening 501a.

An internal space formed by extending the lever opening 512 may be provided within the lever 510. The internal space may receive the block lever 520 and may include a space for the block lever 52 to move in response to the key door 302 being entered.

As the key door 302 is inserted inwards of the lever 510, the block lever 520 may be pressed in its direction of movement. The block lever 520 may only perform its function when the block lever is moved in the desired direction.

Accordingly, a configuration is required to guide its movement.

The first lever body 521 of the block lever 520 may include a block lever guide 521d that may guide the movement of the block lever 520. The block lever guide 521d may be located adjacent to the block lever pusher 521a and extend in the first direction. The block lever guide 521d may include a guide recess 521e concavely formed inside the block lever 520. In other words, the guide recess 521e may be formed concave in a direction opposite to a direction toward the rotation axis.

In response to the guide recess 521e, the lever 510 may include a lever guide 514 that is seated in the guide recess 521e to guide a distance that the block lever 520 is movable and protrudes in the direction of the guide recess 521e. The lever guide 514 and the guide recess 521e may have a structure similar to that of a groove in which a protruding portion and the shape of the protruding portion are arranged to be movable.

The guide recess 521e and the lever guide 514 may be formed interchangeably.

The guide recess 521e and the lever guide 514 may guide the movement of the block lever 520, but may also serve to prevent the block lever 520 from deviating from the lever 510.

The block lever 520 may include a block lever stopper 521c protruding from the block lever 520. The block lever stopper 521c may protrude from the first lever body 521. The block lever stopper 521c may protrude in a direction away from the rotation axis. The position of the block lever stopper 521c may vary depending on the positioning of other components of the lever 510, but such a variation in positioning may not affect its function.

The lever 510 may include a lever stopper 513 located at a position corresponding to the block lever stopper 521c. When the block lever 520 moves a predetermined distance and comes into contact with the lever 510, the block lever stopper 521c and the lever stopper 513 may come into contact with each other. In other words, a timing at which the block lever 520 contacts the lever 510 may be controlled by the guide recess 521e and the lever guide 514 described above, but also be controlled by the block lever stopper 521c and the lever stopper 513.

The lever stopper 513 may be provided to protrude from the lever 510 in a direction facing the block lever 520 to be in contact with the block lever stopper 521c, but may not be limited to any shape, as long as the shape allows for the corresponding function.

The lever 510 may include an inner guide 515 located between the first lever body 521 and the second lever body 522 and having a protruding shape. A first surface of the inner guide 515 facing the first lever body 521 may be adjacent to the first lever body 521 to prevent the block lever 520 from moving further beyond the inner guide 515. In other words, the inner guide 515 may serve to guide the movement of the block lever 520.

The inner guide 515 may be positioned adjacent to the third lever body 523 before the key door 302 presses the block lever 520. This is to prevent the block lever 520 from protruding excessively toward a front side thereof. However, in order not to interfere with the movement of the block lever 520, the inner guide 515 and the block lever 520 may be positioned with some clearance.

The inner guide 515 may have a thickness equal to a distance between the first lever body 521 and the second lever body 522 when the second lever body 522 is as close as possible to the first lever body 521. Such a structure may allow the movement of the block lever 520 to be guided without interfering with a movement of the second lever body 522.

The lever 510 may include a guide inclined surface 516 at a corresponding position of the second lever body 522, which guides the movement of the second lever body 522. The end of the second lever body 522 may contact the guide inclined surface 516. Accordingly, as the second lever body 522 moves, the end of the first lever body 521 may move along the guide inclined surface 516. When the key door 302 enters the inside of the latch 500, the second lever body 522 may move in a direction closer to the first lever body 521, so that a force may be applied to the second lever body 522 in a direction away from the first lever body 521. As a result, the end of the second lever body 522 may move in contact with the guide inclined surface 516. Accordingly, the movement of the second lever body 522 may be guided according to the shape of the guide inclined surface 516.

The end of the second lever body 522 may be provided with an inclined surface protrusion 522a that is bent and extended in a direction opposite to the direction facing the rotation axis and moves in contact with the guide inclined surface 516. The guide inclined surface 516 may function in contact with the inclined surface protrusion 522a. Accordingly, the provision of the inclined surface protrusion 522a may increase the options of positions in which the guide inclined surface 516 may be provided within the lever 510.

The lever 510 may include a safety protrusion 517 that protrudes in a direction escaping the rotation axis. The latch housing 501 may include an opening formed at a position corresponding to the safety protrusion 517.

As seen above, it is dangerous if an object other than the key door 302 enters the latch 500 and causes the door 300 to be detected as closed, thereby generating high frequencies in the cooking apparatus 1. To prevent such a situation, a safety zone may be formed in the latch 500. The safety zone may refer to an angle of rotation of the lever 510 that prevents the lever 510 from returning to its original position when the lever 510 is rotated further, even though all the sensors 530 have been activated. The lever 510 in the safety zone may be configured to disable the sensors 530.

If an object other than the key door 302 is inserted into the latch 500, the lever 510 may be rotated more than necessary as it is inserted deeply. At this time, if the key door 302 enters the safety zone, the cooking apparatus 1 may not be operable. This may be a desirable configuration in terms of safety, as it may prevent further danger, but it is very difficult to return the lever 510 to its original position after the lever has been rotated into the safety zone. Accordingly, in a conventional manner, when the above condition occurs, the cooking apparatus 1 is disassembled by a separate customer service in order to return the lever 510 to its original position, and then the cooking apparatus 1 is restored to its original state.

However, if the safety protrusion 517 is present and the opening is located at a corresponding position, although the lever 510 rotates into the safety zone, a member capable of handling the safety protrusion 517 may be inserted into the formed opening to return the lever 510 to its original position. Accordingly, such a structure may allow the cooking apparatus 1 to be restored to its original state without disassembling the cooking apparatus 1.

The lever 510 may include a lever guard 518 that protrudes more than other components protrude in a direction facing the latch housing 501. If foreign substances enters the inside of the latch 500, the latch 500 may not operate smoothly. The lever guard 518 protrudes more than other components, and thus may prevent foreign substances from entering the latch 500.

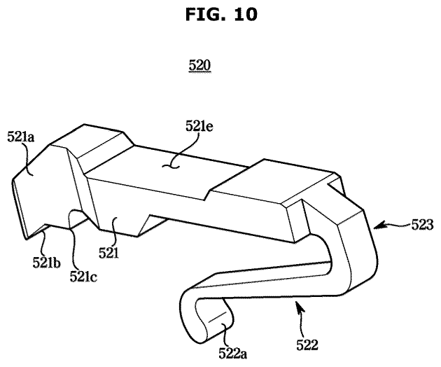

FIG. 10 is a perspective view illustrating the block lever 520 of the latch 500 of FIG. 8.

As shown in FIG. 10, the block lever 520 may include the first lever body 521, the second lever body 522, and the third lever body 523.

The first lever body 521 may include the block lever pusher 521a and the block lever guide 521d.

The width of the block lever pusher 521a may be narrower than the width of the block lever guide 521d. Such a structure may cause the block lever pusher 521a to be more difficult to push when an object other than the key door 302 attempts to enter the inside of the latch 500. Accordingly, the object other than the key door 302 may be more difficult to enter the inside of the latch 500.

The second lever body 522 and the third lever body 523 may have different widths from the first lever body 521. The second lever body 522 and the third lever body 523 are portions that generate an elastic force as the second lever body 522 comes closer to the first lever body 521. Accordingly, the widths thereof may be adjusted to obtain a desired elastic force. When adjusting the widths to obtain the desired elastic force, the second lever body 522 and the third lever body 523 may have different widths from the first lever body 521.

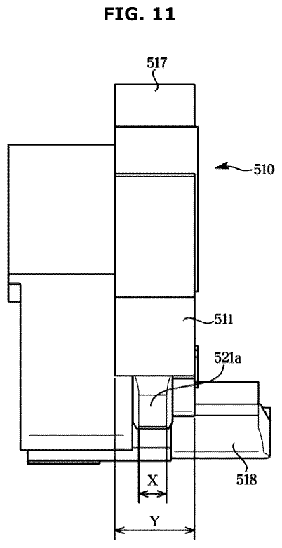

FIG. 11 is a front view illustrating the lever 510 and the block lever 520 of the latch 500 of FIG. 8.

As shown in FIG. 11, the width of the block lever pusher 521a may be narrower than the width of the lever hook 511.

Furthermore, the block lever pusher 521a may have a shape whose width becomes narrower towards the end. In other words, the width of the block lever pusher 521a may become narrower in the direction toward the key door opening 501a. Such a structure may cause an object entering the key door opening 501a to be more difficult to push the block lever pusher 521a. Accordingly, the object other than the key door 302 may be more difficult to enter the inside of the latch 500.

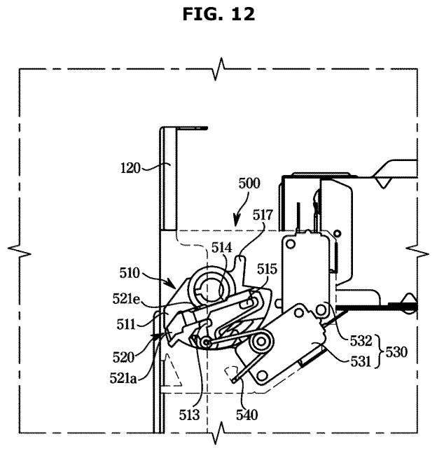

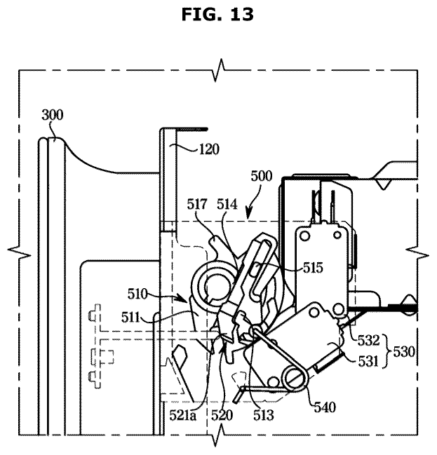

FIGS. 12 and 13 show the latch 500 when the door 300 of the cooking apparatus 1 is open and closed, respectively.

More specifically, FIG. 12 is an enlarged perspective view illustrating the latch 500 when the door 300 of the cooking apparatus 1 of FIG. 5 is open.

As shown in FIG. 12, when the door 300 is open, the key door 302 may be not inserted into the latch 500. As a result, the lever 510 may not rotate and the block lever 520 may also be located on the key door opening 501a side. In addition, the sensor buttons 531a and 532a (see FIGS. 6 and 7) are not pressed, so that the cooking apparatus 1 may be in a non-operation state.

FIG. 13 is an enlarged perspective view illustrating the latch 500 when the door 300 of the cooking apparatus 1 of FIG. 12 is closed.

As shown in FIG. 13, when the door 300 is closed, the key door 302 may be inserted into the latch 500. As the key door 302 is being inserted, the lever 510 may rotate, the block lever 520 may move to a rear side of the accommodating space of the lever 510, and the first lever body 521 and the second lever body 522 may be close to each other to exert a force to rotate the lever 510 in a reverse direction. In addition, the sensor buttons 531a and 532a (see FIGS. 6 and 7) are all pressed, so that the cooking apparatus 1 may be in an operation state.

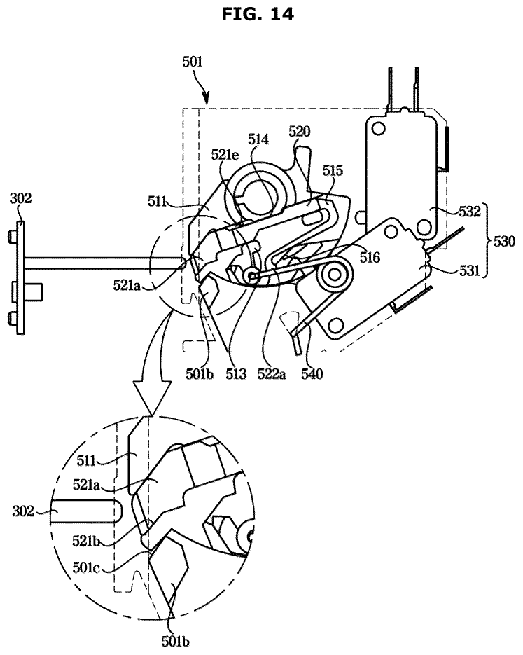

An operation process of the latch 500 will be described in more detail below. FIGS. 14 to 18 are views to illustrate the operation process of the latch 500.

More specifically, FIG. 14 is a side view illustrating the latch 500 and the key door 302 just before the door 300 of the cooking apparatus 1 of FIG. 5 is closed.

As shown in FIG. 14, immediately prior to entry of the key door 302, the block lever pusher 521a and the lever hook 511 of the block lever 520 may be positioned on the key door opening 501a side. The key door 302 may be located toward the block lever pusher 521a rather than the lever hook 511.

In this state, the lever 510 may not rotate and the block lever 520 may also not move. The pusher guide surface 521b of the block lever 520 may only face the anti-rotation guide surface 501c of the anti-rotation portion 501b, but may not contact each other.

The elastic member 540 may exert a force on the block lever 520 such that the key door 520 is in a position in which the key door 302 is not inserted into the latch 500. Accordingly, it is possible to prevent other objects from easily entering the inside of the latch 500.

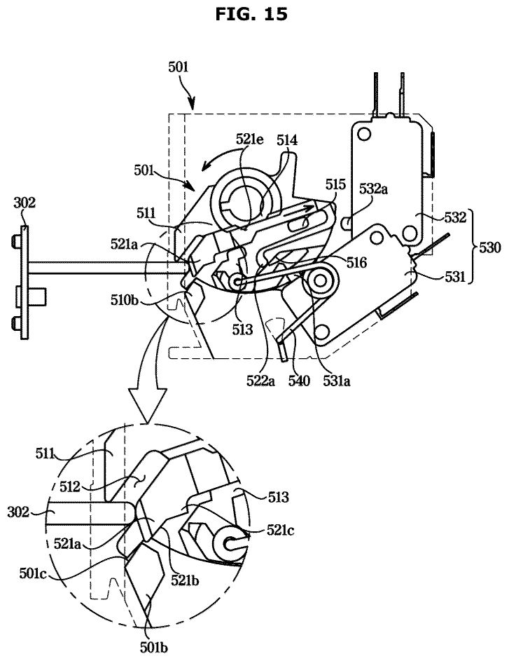

FIG. 15 is a side view illustrating a state in which the key door 302 enters the latch 500 of FIG. 14 and the block lever pusher 521a is released from the anti-rotation portion 501b.

As shown in FIG. 15, when the key door 302 is inserted into the latch 500 while pressing the block lever pusher 521a, the block lever 520 may move in the direction in which the key door 302 is inserted and encounter the anti-rotation portion 501b. As the pusher guide surface 521b of the block lever 520 and the anti-rotation guide surface 501c of the anti-rotation portion 501b come into contact, the block lever 520 may move.

When the block lever 520 is pressed other than by the key door 302, a pressing direction is different. Accordingly, the block lever pusher 521a may come into contact with the anti-rotation portion 501b, and then the block lever 520 may not move over a certain distance. However, in this case, the block lever 520 is pressed in a correct direction by the key door 302, so that the block lever 520 may continue to move without being blocked by the anti-rotation portion 501b.

While the pusher guide surface 521b and the anti-rotation guide surface 501c are in contact, the lever 510 may not rotate upon movement of the block lever 520. This is because the movement of the block lever 520 may be guided by the anti-rotation portion 501b to prevent the block lever 520 from making a movement that rotates the lever 510. The anti-rotation portion 501b may include the anti-rotation guide surface 501c that prevents the block lever 520 from entering the inside of the latch 500 in certain cases.

Upon movement of the block lever 520, the inclined surface protrusion 522a provided at the end of the second lever body 522 may move along the guide inclined surface 516. As a result, the second lever body 522 may move closer to the first lever body 521. Upon such movement, the second lever body 522 may exert a force on the block lever 520 to move away from the first lever body 521, and the block lever 520 may receive a force to return to its original position.

In this state, a first side of the guide recess 521e may not encounter the lever guide 514. As a result, the block lever 520 may still move further into the remaining accommodating space of the lever 510.

Similarly, the block lever stopper 521c may not encounter the lever stopper 513. Accordingly, the block lever 520 may still move further into the remaining accommodating space of the lever 510.

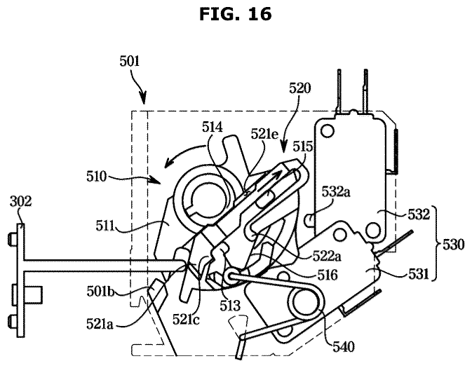

FIG. 16 is a side view illustrating a state in which the key door 302 further enters the latch 500 of FIG. 15 and the block lever 520 does not move further with respect to the lever 510.

As shown in FIG. 16, when the key door 302 enters further, the lever 510 may also rotate. As the lever 510 rotates, the lever hook 511 may pass through the key door hole 302a of the key door 302. If the key door 302 does not have the key door hole 302a, the lever hook 511 may come into contact with the key door 302 and the key door 302 may accordingly not enter further. Accordingly, the above structure of the lever hook 511 may prevent an object that does not have a hole at a suitable position from entering the latch 500.

According to the disclosure, the key door 302 may include the key door hole 302a, and thus the key door 302 may enter further. As the key door 302 enters further, the block lever 520 may move further into the accommodating space of the lever 510. When the key door 302 moves, the lever 510 may be guided by the guide recess 521e and the lever guide 514. In addition, as the inner guide 515 moves while contacting one surface of the first lever body 521, the inner guide 515 may also guide the movement of the lever 510.

After entering to some extent, the key door 302 may come into contact with the lever 510 and exert a force on the lever 510. As a result, the lever 510 may be rotated.

Meanwhile, the inclined surface protrusion 522a, which is the end of the second lever body 522, may continue to move along the guide inclined surface 516. As a result, the second lever body 522 may continue to approach the first lever body 521.

The sensor buttons 531a and 532b of the sensor 530 may be pressed by the rotation of the lever 510. In particular, the first sensor button 531a of the first sensor 531 may be pressed. In the case of a single sensor 530, the closing of the door 300 may be detected thereby. Typically, two or more sensors 530 may be used to comply with international standards, so the closing of the door 300 may be detected by another sensor 530 also detecting.

Then, as the key door 302 continues to enter, the lever guide 514 of the lever 510 may come into contact with the first side of the guide recess 521e of the block lever 520. At the same time, the block lever stopper 521c of the block lever 520 may come into contact with the lever stopper 513 of the lever 510. At this point, the block lever 520 stops moving relative to the lever 510.

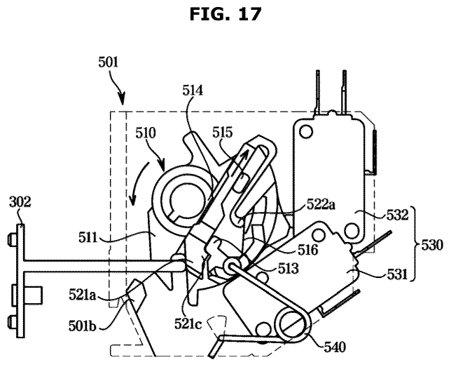

FIG. 17 is a side view illustrating a timing at which the key door 302 further enters the latch 500 of FIG. 16 and a direction of the force applied by the elastic member 540 to the lever 510 is changed.

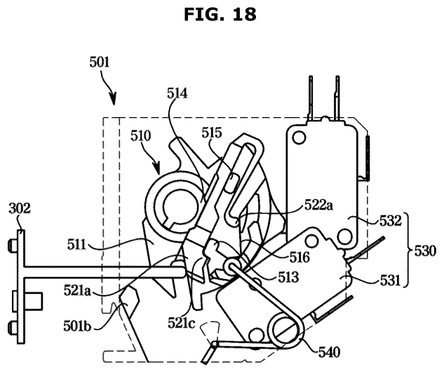

Until the previous state, the elastic member 540 may apply a force to rotate the lever 510 in the reverse direction. However, as shown in FIG. 18, after a point at which the elastic member 540 is coupled to the lever 510 passes a point at which it is closest to the rotation axis, the elastic member 540 may apply a force so as to rotate the lever 510 in a rotating direction. Accordingly, after the door 300 has been closed to a certain extent, it is determined that the user's intention to close the door 300 may become relatively clear, thereby allowing the door 300 to be closed easily.

FIG. 18 is a side view illustrating that the key door 302 further enters the latch 500 of FIG. 17 to allow the second sensor 532 to be detected.

As shown in FIG. 18, the key door continues to enter, causing the lever 510 to rotate further, and the lever 510 eventually may press the second sensor button 532a of the second sensor 532.

In this state, both the first sensor 531 and the second sensor 532 are in a detection state, so that the cooking apparatus 1 may be operated.

When the door 300 is open, the operation described above may be reversed. In this case, as the second lever body 522 attempts to move away from the first lever body 521, the block lever 520 may receive a force to move towards the lever opening 512. In other words, the block lever 520 may move to its original operable position.

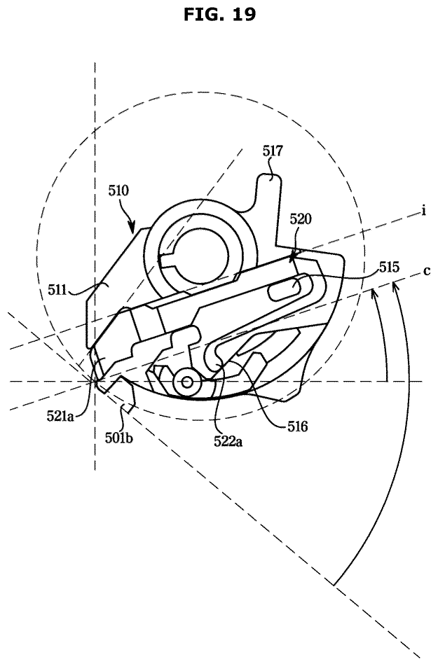

FIG. 19 is a side view illustrating the latch 500 according to a second embodiment of the present disclosure.

The operations described above may be represented in terms of an angle. A trace along which the first lever body 521 moves may be denoted as a straight line i. At this time, the straight line i may be located below the rotation axis. A straight line c is parallel to the straight line i and may be denoted as a straight line tangent to the outermost end of the block lever 520.

At this time, an angle between the horizontal line and the straight line c may have a value greater than 0° and less than 45°. When a concentric circle centered on the rotation axis is drawn at a point of contact with the anti-rotation portion 501b, an angle between the tangent line and the straight line c may have a value less than 90°.

Various variations of the first embodiment are described below. Configurations that duplicate the first embodiment or portions that provide redundant functionality have been omitted from the description. However, despite the omission, it should be understood that the embodiment is still considered to include the corresponding configurations.

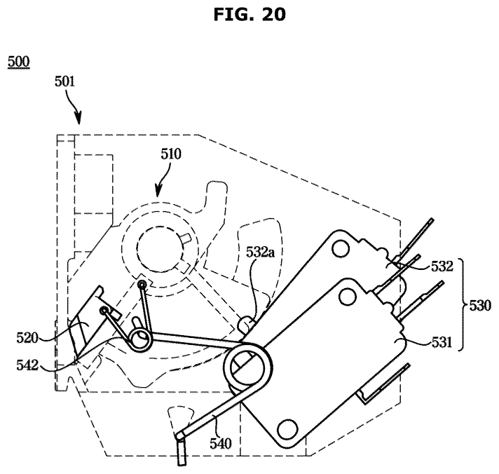

FIG. 20 is a side view illustrating the latch 500 according to the second embodiment of the present disclosure.

As shown in FIG. 20, the block lever 520 and the second elastic member 540 may function together to provide the function of the block lever 520 as seen in the first embodiment.

The elastic member 540 of the first embodiment may be the first elastic member 540 in the description of the second embodiment.

The latch 500 may include a second elastic member 542 connecting the block lever 520 and the lever 510.

When the key door 302 presses the block lever 520, the block lever 520 is accommodated in the lever 510 and the operations as previously described occurs. At this time, because the second elastic member 542 is exerting a force to position the block lever 520 in the direction of the lever opening 512, a force such as the elastic force generated by the first lever body 521 and the second lever body 522 approaching each other in the first embodiment is generated.

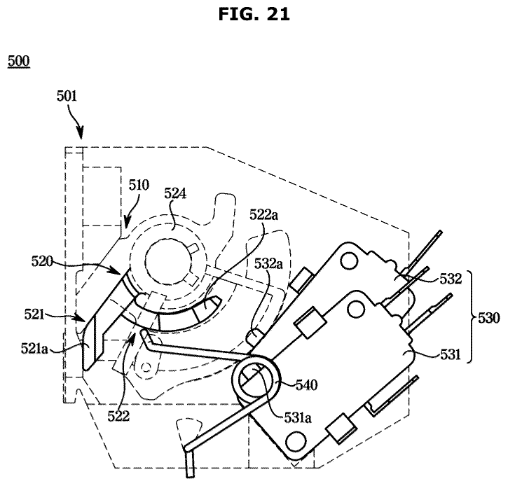

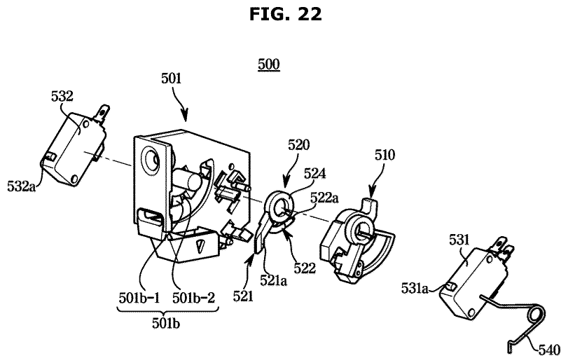

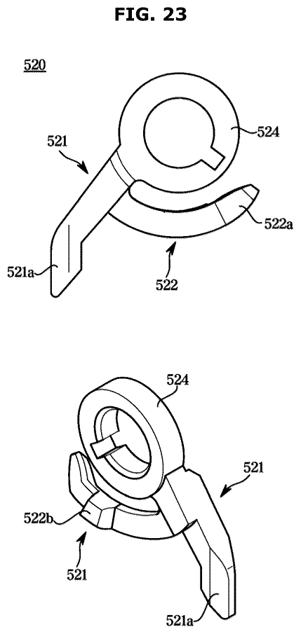

FIG. 21 is a side view illustrating the latch 500 according to a third embodiment of the present disclosure. FIG. 22 is an exploded perspective view illustrating the latch 500 of FIG. 21 disassembled. FIG. 23 is a perspective view illustrating the block lever 520 of the latch 500 of FIG. 21.

As shown in FIGS. 21 to 23, the block lever 520 may include the first lever body 521 extending in the first direction and having one end received in the lever opening 512 side of the lever 510, and the second lever body 522 coupled to a side portion of the first lever body 521 and extending in the second direction.

The block lever 520 may share the same rotation axis as that of the lever 510 and may include a rotation body 524 that is provided in a donut shape around the rotation axis. In this case, the block lever 520 may be stably rotated by the rotation body 524.

The first lever body 521 may be coupled to the rotation body 524.

The first lever body 521 and the second lever body 522 may be brought closer together and elastically biased to move the block lever 520 in the original direction of the block lever 520. In the first embodiment, the movement by which the first lever body 521 and the second lever body 522 approach each other may be in the same plane. However, in the third embodiment, the first lever body 521 and the second lever body 522 may be brought closer by torsion, and an elastic force may be exerted in the direction in which the first lever body 521 and the second lever body 522 are brought closer, thereby generating a force to move the block lever 520.

The inclined surface protrusion 522a of the second lever body 522 may move while contacting the guide inclined surface 516 of the lever 510. The inclined surface protrusion 522a may be brought closer to the first lever body 521 by the guide inclined surface 516. The direction of getting closer may be in a direction perpendicular to the plane formed with reference to FIG. 21.

The first lever body 521 may include a block lever protrusion 522b that protrudes in a direction toward the latch housing 501. The latch housing 501 may include the anti-rotation portion 501b recessed so as to accommodate the block lever protrusion 522b. The anti-rotation portion 501b may include a first anti-rotation portion 501b-1 provided so that the key door 302 is accommodated in the latch 500 and the block lever protrusion 522b may move. The anti-rotation portion 501b may include a second anti-rotation portion 501b-2 extending from the first anti-rotation portion 501b-1 and recessed to a greater depth than the first anti-rotation portion 501b-1. The block lever protrusion 522b accommodated in the second anti-rotation portion 501b-2 may no longer rotate in the desired direction of rotation. As a result, the rotation of the lever 510 may also stop.

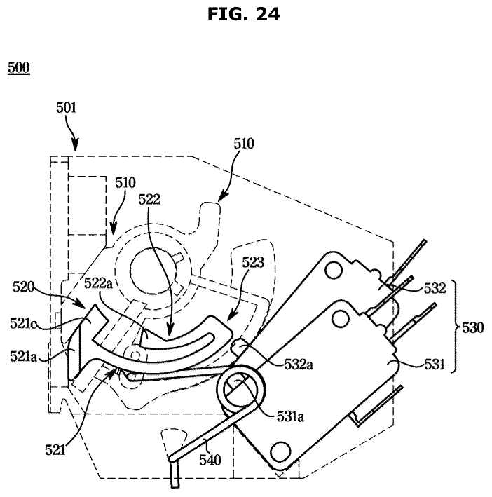

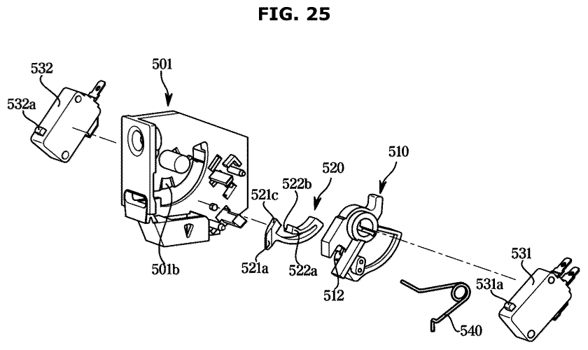

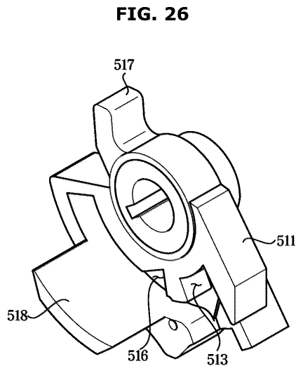

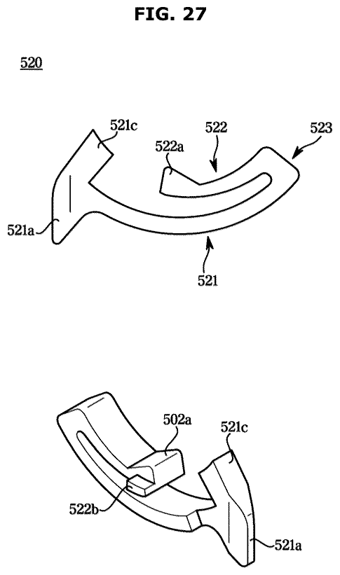

FIG. 24 is a side view illustrating the latch 500 according to a fourth embodiment. FIG. 25 is an exploded perspective view illustrating the latch 500 of FIG. 24 disassembled. FIG. 26 is a perspective view illustrating the lever 510 of the latch 500 of FIG. 25 from the rear. FIG. 27 is a perspective view illustrating the block lever 520 of FIG. 24.

As shown in FIGS. 24 to 27, the block lever 520 may include the first lever body 521 extending in the first direction, the second lever body 522 extending in the second direction forming a predetermined angle with the first direction, and the third lever body 523 coupled to one end of the first lever body 521 and one end of the second lever body 522.

The first lever body 521 may include the block lever pusher 521a protruding in the direction toward the key door opening 501a.

The other end of the block lever pusher 521a extending in the third direction may include the block lever stopper 521c. The lever 510 may include the lever stopper 513 that stops rotation when the block lever pusher 521a rotates at a certain angle at a position in which the block lever pusher 521a is accommodated. The lever stopper 513 may be provided in the form of a groove. The lever stopper 513 may be recessed just enough to allow the block lever pusher 521a to rotate at a predetermined angle.

The second lever body 522 may include the inclined surface protrusion 522a including an inclined surface at an end thereof. The lever 510 may include the guide inclined surface 516 provided at a position corresponding to the inclined surface protrusion 522a. The inclined surface protrusion 522a may move while contacting the guide inclined surface 516, and such movement may allow the first lever body 521 and the second lever body 522 to be brought closer. At this time, an elastic force may act in a direction in which the first lever body 521 and the second lever body 522 move apart. Accordingly, when the key door 302 is inserted into the latch 500, the block lever 520 may be elastically biased to return to its original position.

The second lever body 522 may include the block lever protrusion 522b protruding in a direction toward the latch housing 501. The latch housing 501 may include the anti-rotation portion 501b at a position corresponding to the block lever protrusion 522b. The method in which the block lever protrusion 522b and the anti-rotation portion 501b interact and function, as well as the detailed configuration features, are the same as those of the second embodiment.

While the present disclosure has been particularly described with reference to exemplary embodiments, it should be understood by those of skilled in the art that various changes in form and details may be made without departing from the spirit and scope of the present disclosure.

What is claimed is:

1. A cooking apparatus, comprising:
a housing;
a door rotatably coupled to the housing, and including a key door protruding rearward; and
a latch provided in the housing to lock the door, and configured to detect opening or closing of the door;
wherein the latch comprises:
a latch housing coupled to the housing;
a lever rotatably coupled to the latch housing, and rotatable about a rotation axis; and
a block lever slidably coupled to the lever to prevent or allow a rotation of the lever;
wherein the block lever is configured to be pressed by the key door to slide to allow the rotation of the lever in response to the door being closed, and is configured to return to its an original position by an elastic force of the lever in response to the door being opened.

2. The cooking apparatus of claim 1, wherein the block lever includes:
a first lever body extending in a first direction;
a second lever body extending in a second direction forming an angle with respect to the first direction, and having one end in contact with the inside of the lever; and
a third lever body having one end coupled to an other end of the first lever body and an other end coupled to an other end of the second lever body, and
in response to the door being closed, the first lever body is configured to be pressed by the key door to be brought closer to the second lever body so that an elastic force is accumulated in the block lever.

3. The cooking apparatus of claim 2, wherein
the lever includes a lever opening provided at a position at which the key door is to be entered into in response to the door being closed, and
the first lever body includes:
a block lever pusher received in the lever opening and in contact with the key door; and
a block lever guide extending from the block lever pusher in the first direction, and configured to guide a movement of the block lever.

4. The cooking apparatus of claim 3, wherein
the latch housing includes a key door opening provided at a position at which the key door is to be entered in response to the door being closed,
the lever further includes a lever hook extending from the rotation axis in a direction toward the key door opening,
the key door includes a key door hole to receive the lever hook, and
in response to the key door entering into the inside of the lever, the lever hook is received in the key door hole to allow the lever to rotate.

5. The cooking apparatus of claim 4, wherein
the lever hook and the block lever pusher are received in the key door opening, and
a width of the block lever pusher is narrower than a width of the lever hook.

6. The cooking apparatus of claim 4, wherein the block lever pusher becomes narrower in width towards the key door opening.

7. The cooking apparatus of claim 4, wherein
the block lever pusher includes a pusher guide surface that limits a movement of the block lever pusher on a surface facing in a direction opposite to the direction toward the key door opening, and
the latch housing further includes an anti-rotation portion that is located adjacent to the key door opening, protrudes in the direction opposite to the direction toward the key door opening, and includes an anti-rotation guide surface provided by a predetermined distance so as to prevent the lever from rotating while the block lever moves the predetermined distance.

8. The cooking apparatus of claim 3, wherein
the block lever guide includes a guide recess formed concave in a direction opposite to a direction toward the rotation axis, and extending in the first direction by a distance that the block lever is movable, and
the lever includes a lever guide seated in the guide recess to guide the distance that the block lever is movable, and protruding in a direction of the guide recess.

9. The cooking apparatus of claim 2, wherein
the block lever further includes a block lever stopper protruding in a direction away from the rotation axis, and
the lever further includes a lever stopper configured to stop a movement of the block lever by contacting the block lever stopper after the block lever is moved a predetermined distance.

10. The cooking apparatus of claim 2, wherein
the lever includes an inner guide disposed at a position surrounded by the first lever body, the second lever body, and the third lever body, and
the inner guide is configured to guide a movement of the block lever by moving in contact with one surface of the inner guide in response to the block lever being moved.

11. The cooking apparatus of claim 2, wherein the lever includes a guide inclined surface in contact with an end of the third lever body and configured to guide the third lever body to approach the first lever body in response to the key door being entered into the inside of the latch, the guide inclined surface being formed on the inside of the lever.

12. The cooking apparatus of claim 11, wherein the third lever body further includes an inclined surface protrusion bent and extended at the end thereof in a direction opposite to the direction toward the rotation axis, and moving in contact with the guide inclined surface.

13. The cooking apparatus of claim 1, wherein
the lever includes a lever hook extending from one side of the lever and having an end contacting the key door in response to the key door being entered into,
the block lever is located on the inside of the lever, a width of the block lever being narrower than a width of the lever hook, and
the latch further includes an elastic member connecting the block lever and the lever to elastically bias the block lever in a direction toward the key door.

14. The cooking apparatus of claim 1, wherein
the block lever includes a first lever body extending in a first direction, and a second lever body coupled to a side portion of the first lever body and extending in a second direction,
the second lever body includes an inclined surface protrusion bent in a direction toward the latch housing at an end thereof,
the inclined surface protrusion contacts the inside of the lever,
the lever includes:
a guide inclined surface moving in contact with the bent end of the second lever body; and
a lever guide having the shape of a groove in which the second lever body is accommodated and guided, and
in response to the door being closed, the first lever body is pressed by the key door to be brought closer to the second lever body in a direction of the rotation axis so that an elastic force is accumulated in the block lever.

15. The cooking apparatus of claim 2, wherein
the second lever body includes a block lever protrusion protruding in a direction toward the latch housing and including an inclined surface,
the latch housing further includes an anti-rotation guide surface having the shape of groove to receive the block lever protrusion, and provided by a predetermined distance so as to prevent the lever from rotating while the block lever moves the predetermined distance, and
in response to the door being closed, the first lever body is pressed by the key door to be brought closer to the second lever body so that an elastic force is accumulated in the block lever.
